(19) United States
(12) Patent Application Publication
(10) Pub. No.: US 2010/0162177 A1
(43) Pub. Date: Jun. 24, 2010

(54) INTERACTIVE ENTERTAINMENT SYSTEM AND METHOD OF OPERATION THEREOF

(75) Inventors: David A. Eves, Crawley (GB); Richard S. Cole, Redhill (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/063,119

(22) PCT Filed: Aug. 10, 2006
(86) PCT No.: PCT/IB06/52766

§ 371 Date: Feb. 7, 2008

(30) Foreign Application Priority Data
Aug. 12, 2005 (EP) 05107460.7

(51) Int. Cl. G06F 3/033

(52) U.S. Cl. 715/863

(57) ABSTRACT

An interactive entertainment system comprises a plurality of devices providing an ambient environment, gesture detection means for detecting a gesture of a user, and control means for receiving an output from the gesture detection means and for communicating with at least one device. The control means is arranged to derive from the output a location in the ambient environment and to change the operation of one or more devices in the determined location, according to the output of the gesture detection means.

This invention relates to an interactive entertainment system and to a method of operating an interactive entertainment system.

Many different types of entertainment systems are known. From conventional televisions through to personal computers and game consoles, interactive games can be utilised on such devices. Development of these systems and of units to interoperate with these systems is ongoing. For example, “EPS—an interactive collaborative game using non-verbal communication” by Marie-Louise Rinman et al., Proceedings of the Stockholm Music Acoustics Conference, Aug. 6-9, 2003 (SMAC 03), Stockholm, Sweden describes an interactive game environment, referred to as EPS (expressive performance space), EPS involves participants in an activity using non-verbal emotional expressions. Two teams use expressive gestures in either voice or body movements to compete. Each team has an avatar controlled either by singing into a microphone or by moving in front of a video camera. Participants/players control their avatars by using acoustical or motion cues. The avatar is navigated/moved around in a three-dimensional distributed virtual environment. The voice input is processed using a musical cue analysis module yielding performance variables such as tempo, sound level and articulation as well as an emotional prediction. Similarly, movements captured from the video camera are analyzed in terms of different movement cues.

This system and similar systems such as Sony's Eyetoy product detect the movement of one or more individuals to change the on-screen display of an avatar representing the user(s) according to the movements of the participant(s). The user's actions are limited to affecting the virtual world provided by the game with which they are interacting.

It is therefore an object of the invention to improve upon the known art.

According to a first aspect of the present invention, there is provided an interactive entertainment system comprising a plurality of devices providing an ambient environment, gesture detection means for detecting a gesture of a user, and control means for receiving an output from the gesture detection means and for communicating with at least one device, the control means arranged to derive from the output a location in the ambient environment and to change the operation of one or more devices in the determined location, according to the output of the gesture detection means.

According to a second aspect of the present invention, there is provided a method of operating an interactive entertainment system comprising operating a plurality of devices to provide an ambient environment, detecting a gesture of a user, determining a location in the ambient environment and changing the operation of one or more devices in the determined location, according to the detected gesture.

Owing to the invention, it is possible to provide a set of devices that provide an ambient environment surrounding a user where gestures made by a user will be interpreted as relating to specific locations in the ambient environment, and devices in the specified locations will modify accordingly. A far greater immersive experience is rendered to the user, and the virtual world of, for example, a game, is extended into the real world of the user.

A combination of gesture recognition and a rendering engine are used to create a form of creative gaming or entertainment based on triggering effects around an ambient environment. By detecting movements of, for example, hands, relative to a user, actions can be made to initiate the rendering of effects directed to appropriate locations in the space. These could be in reaction to events occurring in those locations or just in their own right.

A number of sensors on the body (or in a device held by the player) provide feedback to a gesture mapper. This could be on the player or remote host machine. This uses the sensor inputs for example, acceleration relative to gravity, location with respect to a point of reference, angle of joints, etc. to create a model of the player's actions. So for example this could work out the current stance of the player which can be matched against a set of stereotypical values.

Each of these states that the player can be in could then be used as a trigger for a particular piece of content and to indicate a location for the content to be rendered. Optionally a game could be running as part of the system that reacts to the actions of the player. This game could also provide trigger events and these could also be modified by the game status for example, changing the rate of events, or calculating scores.

Advantageously, the gesture detection means is arranged to detect a direction component of the user gesture, and the direction component of the user gesture determines which device of the plurality of devices changes operation. By detecting the predominate direction of the user's gesture and identifying a device or devices that are located in a region corresponding to the direction of the user's gesture, an interactive experience is readily rendered. Preferably, the gesture detection means is arranged to detect a movement component of the user gesture, and the movement component of the user gesture determines the nature of the change in operation of the device.

The user's actions are mapped to regions of the ambient environment used in the control means' location model (for example using compass points) and events are generated and executed in those locations. For example this allows the user to take the role of a wizard casting spells. These result in various effects in the space around them. Different spells could be selected by a range of means, for example using differing gestures, selecting from a menu or pressing alternative buttons. Similar games involving firing weapons or even throwing soft objects can be envisaged.

Preferably, a device is arranged to render an event in a defined location and the control means is arranged to ascertain whether the defined location matches the location derived from the output of the gesture detection means.

In one embodiment, the gesture detection means comprises one or more wearable detection components. The movements of the user can be detected in many ways, for example by using accelerometers in gloves or a control device or visual tracking from a web cam. Also a wearable motion sensor device such as a sensor jacket could be used to detect such actions.

Embodiments of the present invention will now be described, by way of example only, with reference to the accompanying drawings, in which:-

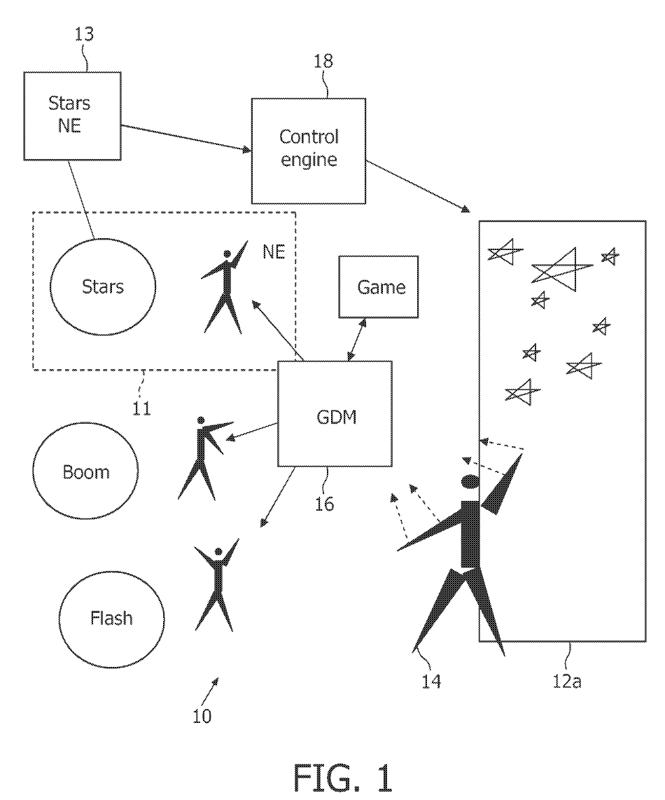

FIG. 1 is a schematic diagram of an interactive entertainment system,

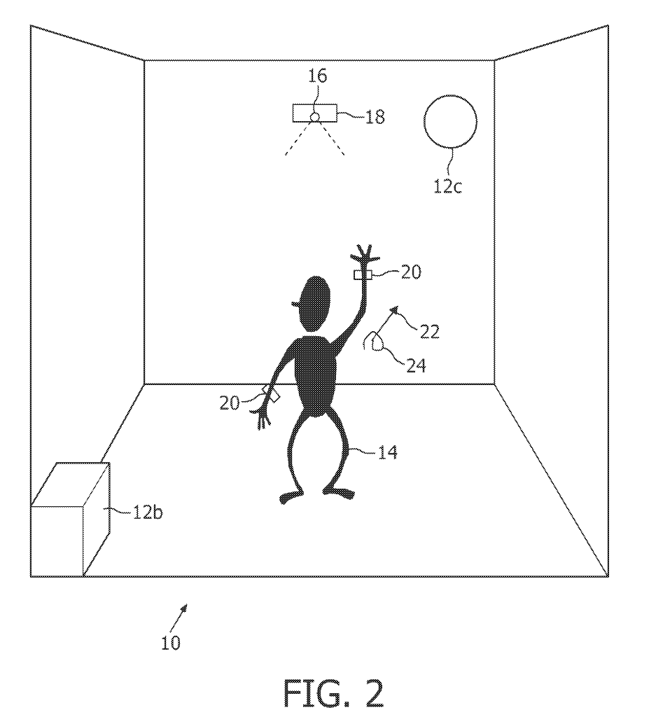

FIG. 2 is a diagram, similar to FIG. 1, of the interactive entertainment system, and

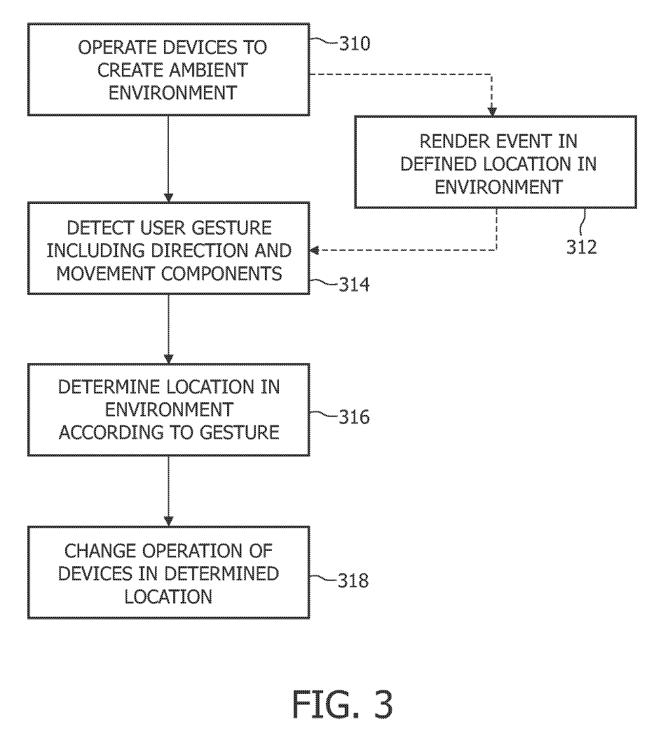

FIG. 3 is a flowchart of a method of operating an interactive entertainment system.

The interactive entertainment system 10 shown in FIGS. 1 and 2 comprises a plurality of devices 12 providing an ambient environment surrounding a user 14. The devices 12 can each provide one or more aspects of the environment and can be made up of electronic, mechanical and fabric devices, such as lights, displays, speakers, heaters, fans, furniture actuators, projectors etc. In FIG. 1, a projected light display 12a showing a collection of stars is illustrated. In FIG. 2, a heater 12b and a lamp 12c are shown.

The system 10 also includes gesture detection means 16 for detecting a gesture of the user 12, and control means 18 for receiving an output from the gesture detection means 16. The gesture detection means 16 also includes wearable detection components 20. The gesture detection means 16 can function solely by using a camera and image detection software to identify a user's movements, or can be based upon data received via a wireless link from the wearable components 20 which can monitor the movement of the user's limbs that carry the specific components 20. The detection of gesture can also be via a combination of the imaging and the feedback from the components 20.

The control means 18 is for communicating with the devices 12 that are generating the ambient environment, and the control of the devices 12 in the environment can be structured in many different ways, for example, directly with command instructions, or indirectly with generic terms that are interpreted by the receiving devices.

The control means 18 is arranged to derive from the output of the gesture detection means 16 a location in the ambient environment. In the example shown in FIG. 1, the user 12 is making a specific gesture with their arms, that is identified as corresponding to the desire for stars in the area NE of the environment.

This corresponds to the stored data 11 which relates the detected user gesture linked to the stars component. This leads to the event 13 comprised of “stars NE” being passed to the engine 18. This is used to change the operation of one or more devices in the determined location, according to the output of the gesture detection means 16. The mechanism by which the change is achieved can be one of a number of different ways, according to the set-up of the system 10. The engine 18 can generate precise parameter instructions for devices in the system 10, or new objects can be created (or existing ones modified by the engine 18) that are passed to one or more devices to be rendered by the receiving device to the extent that they are able. An example of the latter system is known from, for example, WO 02/092183.

Two further stored bits of data are shown, with a sound component boom corresponding to a different user gesture, and a third component flash corresponding to yet a third gesture.

The gesture detection means 16 can be arranged to detect a direction component 22 (shown in FIG. 2) of the user gesture. The direction component 22 of the user gesture determines which device 12 of the devices generating the ambient environment changes operation. The gesture detection means 16 can also detect a movement component 24 of the user gesture. The movement component 24 of the user gesture can be used to determine the nature of the change in operation of the device.

In FIG. 2, the user 14 has made a spiral gesture with their right hand and then pointed in the direction of the lamp 12c. The spiral gesture is the movement component 24 of the gesture and the pointing is the direction component 22 of the gesture. The direction component 22 will be detected by the gesture detection means 16 and the control means will translate this into a change in operation of the device 12c, the direction component 22 indicating the location of the device to be changed. The movement component 24 indicates the type of action that the user has made, in this example, the spiral gesture may correspond to the casting of a fire spell, and the change in operation of the lamp 12c may be to flash red and orange to reflect the fire spell.

The system may cue player actions by creating effects in locations which need to be countered or modified by the actions of the player. This is rather like a 3 dimensional form of ‘bash-a-mole’. A device 12 in the system 10 is arranged to render an event in a defined location and the control means 18 is arranged to ascertain whether the defined location matches the location derived from the output of the gesture detection means 16.

The system allows the creation of entertainment based on physical experiences located in real world spaces. This opens the opportunity for new forms of entertainment experience, not necessarily always based around on-screen content. The system supports a user being able to stand in a space and, for example, throw explosions, thunderbolts and green slime.

It is also possible that this form of interface could be used in an authoring environment for effects creation systems, using gestures to adjust parts of the experience (like a conductor). It also opens up possibilities for novel interaction metaphors for control of other devices.

FIG. 3 summarises the method of operating the devices. The method comprises operating the plurality of devices to provide an ambient environment (step 310), detecting a gesture of a user optionally including the direction and movement components of the gesture (step 314, determining a location in the ambient environment (step 316) and changing the operation of one or more devices in the determined location, according to the detected gesture (step 318). The method can also comprise rendering an event in a defined location and ascertaining whether the defined location matches the determined location (step 312).

1-14. (canceled)

15. An interactive entertainment system comprising a plurality of devices (12) providing an ambient environment, gesture detection means (16) for detecting a gesture of a user (14), and control means (18) for receiving an output from the gesture detection means (16) and for communicating with at least one device (12), the control means (18) arranged to derive from the output a location in the ambient environment and to change the operation of one or more devices (12) in the determined location, according to the output of the gesture detection means (16), wherein a device (12) is arranged to render an event in a defined location and the control means (18) is arranged to ascertain whether the defined location matches the location derived from the output of the gesture detection means (16).

16. A system according to claim 15, wherein the gesture detection means (16) is arranged to detect a direction component (22) of the user (14) gesture.

17. A system according to claim 16, wherein the direction component (22) of the user (14) gesture determines which device (12) of the plurality of devices (12) changes operation.

18. A system according to claim 15, wherein the gesture detection means (16) is arranged to detect a movement component (24) of the user (14) gesture.

19. A system according to claim 18, wherein the movement component (24) of the user (14) gesture determines the nature of the change in operation of the device (12).

20. A system according to claim 15, wherein the gesture detection means (16) comprises one or more wearable detection components (20).

21. A method of operating an interactive entertainment system comprising operating a plurality of devices (12) to provide an ambient environment, rendering an event in a defined location, detecting a gesture of a user (14), determining a location in the ambient environment, ascertaining whether the defined location matches the determined location and changing the operation of one or more devices (12) in the determined location, according to the detected gesture.

22. A method according to claim 21, wherein the detecting of a gesture of a user (14) comprises detecting a direction component (22) of the user (14) gesture.

23. A method according to claim 22, wherein the direction component (22) of the user (14) gesture determines which device (12) of the plurality of devices (12) changes operation.

24. A method according to claim 21, wherein the detecting of a gesture of a user (14) comprises detecting a movement component (24) of the user (14) gesture.

25. A method according to claim 24, wherein the movement component (24) of the user (14) gesture determines the nature of the change in operation of the device (12).

26. A method according to claim 21, wherein the detecting of a gesture of a user (14) comprises taking readings from one or more wearable detection components (20).
